(19) United States
(12) Patent Application Publication
(10) Pub. No.: US 2026/0255078 A1
(43) Pub. Date: Aug. 27, 2026

(54) PHOTOELECTRIC CONVERSION APPARATUS AND EQUIPMENT

(71) Applicant: CANON KABUSHIKI KAISHA, Tokyo (JP)

(72) Inventor: SATORU MIKAJIRI, Gunma (JP)

(21) Appl. No.: 19/543,161

(22) Filed: Feb. 18, 2026

(30) Foreign Application Priority Data
Feb. 21, 2025 (JP) 2025-027217

(51) Int. Cl. H04N 25/47; H04N 25/707

(52) U.S. Cl. CPC H04N 25/47; H04N 25/707

(57) ABSTRACT

A photoelectric conversion apparatus comprises a plurality of detecting elements each configured to detect light and output a detection signal, a logic circuit configured to output the number of detection signals output from the plurality of detecting elements in parallel, and a counter configured to be supplied with an output of the logic circuit. The counter accumulates a value corresponding to an output of the logic circuit.

### BACKGROUND

### Field of the Technology

The present disclosure relates to a photoelectric conversion apparatus and equipment using the photoelectric conversion apparatus.

### Description of The Related Art

One of the image sensors is an event-based sensor (also called a dynamic vision sensor or the like). In this sensor, each event pixel arranged on a two-dimensional array monitors changes in the amount of incident light, and generates three-value information indicating whether the amount of incident light has increased (on-event occurrence), decreased (off-event occurrence), or remained unchanged (no-event occurrence). Furthermore, this information is configured so that data is output only from a pixel region where either an on-event or an off-event has occurred. Japanese Patent Laid-Open No. 2020-96347 describes a solid-state image capturing element where a pixel for event detection and a pixel for pixel signal output are arranged.

### SUMMARY

The present disclosure provides a technique capable of suppressing an increase in scale of a circuit for event detection.

According to one aspect of the disclosure, there is provided a photoelectric conversion apparatus comprising a plurality of detecting elements each configured to detect light and output a detection signal, a logic circuit configured to output the number of detection signals output from the plurality of detecting elements in parallel, and a counter configured to be supplied with an output of the logic circuit, wherein the counter accumulates a value corresponding to an output of the logic circuit.

Features of the present disclosure will become apparent from the following description of embodiments with reference to the attached drawings. The following description of embodiments is described by way of example.

### BRIEF DESCRIPTION OF THE DRAWINGS

FIG. 1 is a view showing the configuration of a photoelectric conversion apparatus;

FIG. 2A is a view for explaining the arrangement of color filters;

FIG. 2B is a view for explaining the arrangement of color filters;

FIG. 2C is a view for explaining the arrangement of color filters;

FIG. 2D is a view for explaining the arrangement of color filters;

FIG. 3 is a view showing an example of the configuration of a pixel for event detection;

FIG. 4 is a view showing an example of the configuration of a photoelectric conversion element;

FIG. 5 is a view for explaining event detection;

FIG. 6 is a view for explaining event detection;

FIG. 7 is a view for explaining the arrangement of pixels for event detection;

FIG. 8 is a view for explaining event detection;

FIG. 9 is a view for explaining event detection;

FIG. 10 is a view for explaining an example where a counter is provided for each pixel; and

FIG. 11 is a view showing an example of application of the photoelectric conversion apparatus according to the present disclosure to equipment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

In each embodiment described below, as an example of a photoelectric conversion apparatus, an image capturing apparatus will mainly be described. However, each embodiment is not limited to the image capturing apparatus, and is also applicable to other examples of the photoelectric conversion apparatus. Other examples are, for example, a distance measurement apparatus (such as an apparatus for distance measurement using focus detection or Time Of Flight (TOF)) and a light measurement apparatus (such as an apparatus for measuring the amount of incident light).

### Embodiment

### Explanation of System

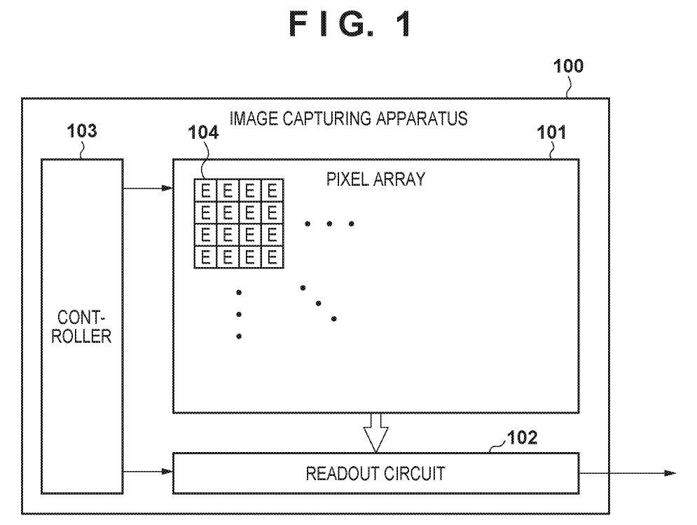

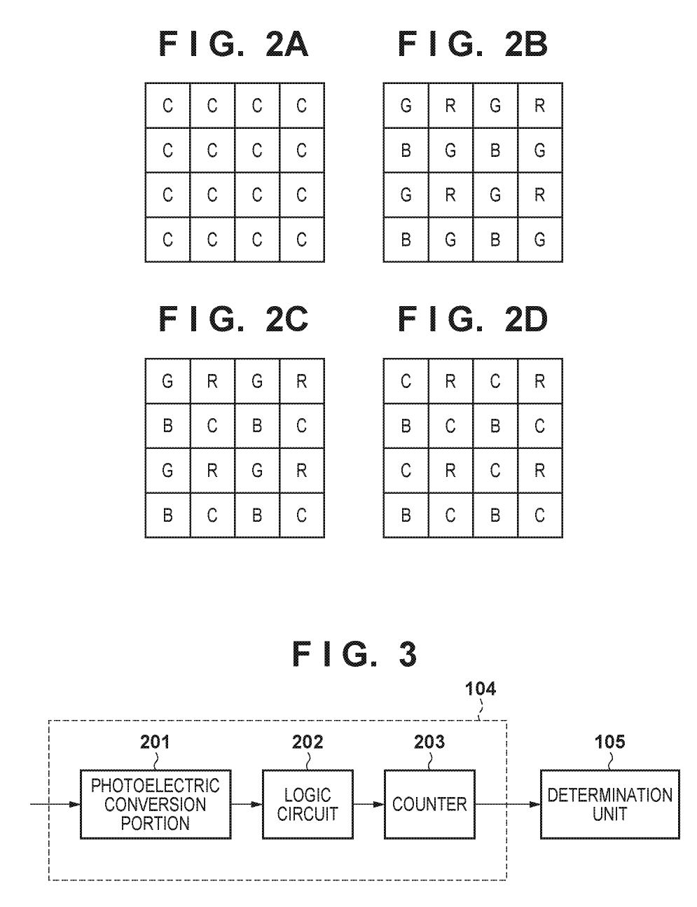

With reference to FIGS. 1 to 2D, the configuration of an image capturing apparatus 100 according to this embodiment will be described. Note that the configuration described in the following embodiment is merely an example, and the present disclosure is not limited to the configuration shown in the drawings. The image capturing apparatus 100 according to the present disclosure is constituted by a pixel array 101, a readout circuit 102, and a controller 103.

In the pixel array 101, pixel blocks 104 are arranged in a two-dimensional array that can detect light amount changes as event information. In the pixel block 104, a plurality of pixels E, each including a detecting element for detecting light, are arranged. In this example, sixteen pixels E are arranged in the pixel block 104. In a light receiving portion of the pixel E, a color filter may be provided for a pixel performing image capturing. For the pixel arranged with the color filter, light enters through the color filter.

An example of the arrangement of color filters will be described with reference to FIGS. 2A to 2D. In FIGS. 2A to 2D, "C" indicates a transparent filter. "R" indicates a red filter. "G" indicates a green filter. "B" indicates a blue filter. FIG. 2A shows a case where all pixels are clear pixels (without color filters). This enables high sensitivity in dark places. FIG. 2B shows a Bayer array of RGGB. This enables acquisition of information for each color. FIG. 2C shows an array of RGCB, and FIG. 2D shows an array of RCCB. These enable event detection by clear pixels, in addition to acquisition of information for each color. The arrangement of color filters can be selected for each application in which the image capturing apparatus is used. Note that the use of color filters does not hinder the implementation of the present disclosure.

The readout circuit 102 reads out the information detected by the pixel array 101, and outputs it to the outside. The readout circuit 102 can be configured to be capable of parallel simultaneous readout of multiple pixels, for example, in units of one row. Alternatively, information may be read out, for example, only from the row where an event has been detected. In this case, to identify the position of the pixel where the event has been detected, a row address for each row may be added to the readout data before outputting it. In a similar manner, as for a column direction, information can be read out only from a column where an event has occurred, and a column address can be added to the readout data before outputting an event value. Furthermore, information may be read out for each pixel block in a combination of rows and columns. The shape of the pixel block is not limited, and may be set as a rectangular region including a plurality of pixels.

The controller 103 controls the pixel array 101 and the readout circuit 102. The controller 103 can generate a reset signal to control initialization of the pixel array 101 or an image capturing operation. The controller 103 supplies a synchronization signal for deciding overall synchronization or an exposure period, a timing signal for controlling a readout operation, a threshold for event detection, and the like to the pixel array 101 and the readout circuit 102, thereby controlling the image capturing apparatus 100.

### Outline of Pixel Block

The outline of the pixel block 104 will be described with reference to FIG. 3. A photoelectric conversion portion 201 captures incident light, and outputs a pulse signal corresponding to the incident light to a logic circuit 202. The logic circuit 202 processes outputs of a plurality of photoelectric conversion portions 201 included in the pixel block 104, and outputs a signal to a counter 203. At this time, the logic circuit 202 outputs the signal to the counter 203 in accordance with the number of detection signals detected in parallel by the photoelectric conversion portions 201

. The accumulated count value of the counter 203 is transmitted to a determination unit 105 in the later stage, and used for detection of event occurrence. The determination unit 105 may be included in the pixel block 104, or may be included in the pixel. The determination unit 105 may be included in the controller 103. The relationship between the output of the logic circuit 202 and the operation of the counter 203 at this time will be described later.

### Photoelectric Conversion Portion

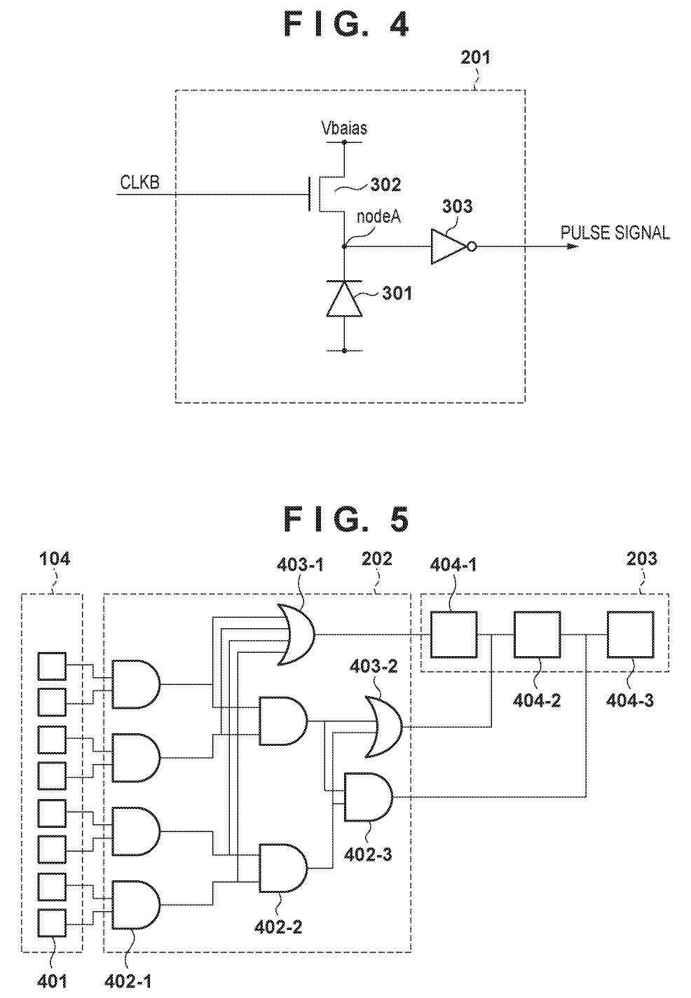

The photoelectric conversion portion 201 will be described with reference to FIG. 4. Here, a case will be described where a SINGLE PHOTON AVALANCHE DIODE (to be referred to as a SPAD hereinafter) is used as a detecting element 301 for light detection. Each photoelectric conversion portion 201 includes the detecting element 301, a switch 302, and an inverter 303. The anode of the detecting element 301 is connected to a ground potential, and the cathode (node A) of the detecting element 301 is connected to one terminal of the switch 302. A bias voltage Vbias is applied to the other terminal of the switch 302. The bias voltage Vbias higher than the breakdown voltage of the detecting element 301 is applied to the detecting element 301 via the switch 302.

The switch 302 is formed by, for example, an NMOS transistor. A clock signal CLKB is connected to the gate of the NMOS transistor. When the clock signal CLKB is set at H level, the switch 302 is turned on (ON state), and the bias voltage Vbias is applied to the detecting element 301. On the other hand, when the clock signal CLKB is set at L level, the switch 302 is turned off (OFF state), so the bias voltage Vbias is not applied to the detecting element 301 and detection is stopped.

The switch 302 also has an aspect as a quenching element which uses the resistance component of the NMOS transistor, that is, a resistance element for stopping the avalanche multiplication phenomenon of the detecting element 301. The operation of the photoelectric conversion portion 201 when a single photon enters will be described below.

When the voltage level of the clock signal CLKB is set at H level, the switch 302 is turned on, and the bias voltage Vbias is applied to the detecting element 301. At this time, the node A is set at the level of the bias voltage Vbias. When a photon enters the detecting element 301, an avalanche multiplication phenomenon occurs. When the avalanche multiplication phenomenon generates an avalanche current, a voltage drop occurs due to the resistance component (quenching resistance) of the switch 302, and the bias voltage Vbias applied to the detecting element 301 drops. When the bias voltage Vbias drops to the breakdown voltage, the avalanche multiplication phenomenon stops. As a result, the avalanche current stops flowing, and the bias voltage Vbias is connected to the detecting element 301 again via the switch 302. When the clock signal CLKB is set at H level again, the bias voltage Vbias is applied to the detecting element 301.

In a case where the detecting element 301 is an SPAD, the phenomenon as described above occurs when a photon enters the detecting element 301. Accordingly, the voltage level of the node A changes as high (Hi) → low (Lo) → high (Hi). The inverter 303 outputs the inverse of the voltage change of the node A. That is, when a photon enters, the inverter 303 outputs a pulse signal of low (Lo) → high (Hi) → low (Lo). Thus, the pulse signal corresponding to the single photon can be generated in the photoelectric conversion portion 201. The bias voltage Vbias can be, for example, about +20 V, but limitation is not made thereto. For example, the anode of the detecting element 301 may be connected to a negative potential.

For the detecting element for light detection, instead of using an avalanche multiplication type photodiode, a charge accumulation type photodiode may be used. In this case, the switch 302 can be configured to reset the photoelectric conversion element in accordance with generation of a predetermined amount of charges. The predetermined amount may be set to be smaller than the saturation charge amount of the photodiode. During a period when the amount of charges generated by the photodiode is smaller than the predetermined amount, the switch 302 does not perform a reset operation. On the other hand, if the charges generated by the photodiode exceeds the predetermined amount, the photodiode is reset. By controlling in this manner, event detection can be performed based on the amount of charges accumulated in the photodiode.

### Logic Circuit and Counter

As the configuration for counting light detection, an example of using the SPAD as the detecting element will be described with reference to FIG. 5. Unnecessary circuits for explanation are not shown in FIG. 5. Pulse signals respectively output from the plurality of pixels 401 in the pixel block 104 are input to the logic circuit 202. The counter 203 counts the pulses output from the logic circuit 202. In this example, the counter 203 is constituted by three series-connected flip-flops 404 functioning as counting portions. The counter 203 can be constituted by more than three series-connected flip-flops 404, there by enabling the counter 203 to count an accumulated value greater than 8, which is output from the logic circuit 202. Outputs of the logic circuit 202 are input to predetermined stages of flip-flops 404-1 to 404-3 functioning as the counting portions, respectively, of the counter 203. As will be described later, the output of the logic circuit 202 is connected to the input of a digit having a predetermined bit weight in the counting portions connected in series.

When a photon enters, the photoelectric conversion portion 201 including the detecting element 301 outputs a pulse signal. The pulse signal is output from the inverter 303 as a pulse signal having a certain time width. The smaller the pulse width, the shorter the event detection interval can be, but the more susceptible to noise and the like it becomes. The larger the pulse width, the longer the event detection interval can be, but the less susceptible to noise it becomes. Hence, the pulse width may be set to an arbitrary pulse width in accordance with the application of an event-based sensor. The pulse width may be set by setting the circuit characteristics of the inverter 303, or using a one-shot circuit that receives the output of the inverter 303 and outputs a pulse with a width of a certain period.

The plurality of pixels 401 are connected to the logic circuit 202. FIG. 5 shows an example where the pixel block 104 includes eight pixels 401. An AND circuit 402-1 having two inputs is connected to two pixels 401. The AND circuit 402-1 receives pulse outputs from the two pixels 401, and outputs H level at the timing when both of the two pulses are at H level. The AND circuits 402-1 are arranged in accordance with the number of the pixels 401, as shown in FIG. 5. The AND circuits are arranged in multiple stages such that the output of one AND circuit is input to the AND circuit in the next stage. The outputs of the AND circuits 402-1 are sequentially connected to the inputs of AND circuits 402-2 in the next stage, as shown in FIG. 5. In this example, the AND circuits in three stages are connected to the eight pixels. Note that the number of pixels included in the pixel block 104 and the number of stages of the AND circuits are merely examples for descriptive convenience, and limitation is not made thereto. If there are sixteen pixels, the logic circuit 202 includes four stages of AND circuits. Note that "-n" of the AND circuit 402-1 represents that it corresponds to the AND circuit in the nth stage. However, when it is unnecessary to distinguish the stages, "-n" may be omitted in the following description. It is also noted that a circuit for detecting the parallel output of two detection signals is not limited to the AND circuit.

Connections are made such that the output of the AND circuit 402-1 in the first stage is input to the AND circuit 402-2 in the second stage, and the output of the AND circuit 402-2 in the second stage is input to an AND circuit 402-3 in the third stage. The output of the AND circuit 402-1 in the first stage represents the product of signals from two pixels 401, the output of the AND circuit 402-2 in the second stage represents the product of signals from four pixels 401, and the output of the AND circuit 402-3 in the third stage represents the product of signals from eight pixels 401. That is, parallel input of signals can be detected from the AND circuit in each stage.

In the example shown in FIG. 5, the counter 203 is a binary counter constituted by the plurality of flip-flops 404-1 to 404-3. The output of the flip-flop 404-1 is connected to the input of the next flip-flop 404-2. In this example, the flip-flops 404-1 to 404-3 are connected in three stages. The flip-flop 404-1 in the first stage, to which the output of a gate circuit 403-1 is input, can function as a counting portion where the counter 203 counts 1 when one pulse is input. In this example, the flip-flop 404-1 is the counting portion corresponding to the smallest digit with the lowest weight, and the flip-flop 404-3 is the counting portion corresponding to the largest digit with the highest weight.

The output of the AND circuit 402-1 in the first stage, which receives pulse signals from the pixels 401, is connected to the input of the flip-flop 404-1 in the first stage constituting the counter 203. The output of the AND circuit 402-2 in the second stage and the output of the AND circuit 402-3 in the third stage are connected to the input of the flip-flop 404-2 in the second stage and the input of the flip-flop 404-3 in the third stage, respectively, which constitute the counter 203. When one pulse is input to the input of the flip-flop 404-2 in the second stage, the counter can count 2. The count value of the counter 203 can be weighted depending on which one of the stages of the flip-flops 404-1 to 404-3 the pulse is input to. In this manner, when one pulse is input to the input of the flip-flop 404-3 in the third stage, the counter 203 can count 4.

The output of the AND circuit 402-1 in the first stage is connected to the input of the least significant bit of the counter 203, and the output of the AND circuit 402-2 in the second stage is connected to the input of the second bit of the counter 203. The output of the AND circuit 402-3 in the third stage is connected to the input of the most significant bit of the counter 203. At this time, if pulses are simultaneously input in parallel to the upper bit and the lower bit of the counter, the pulse to the upper bit is input but the pulse to the lower bit is not input. If pulses are input in parallel to the upper bit and the lower bit of the counter, the gate circuit 403-1 and a gate circuit 403-2 are controlled to pass only the pulse to the upper bit. When a pulse is output from the AND circuit 402-3 in the third stage, the gate circuit 403-2 is controlled not to output the pulse from the AND circuit 402-2 in the second stage. At this time, the gate circuit 403-1 is also controlled not to output a pulse.

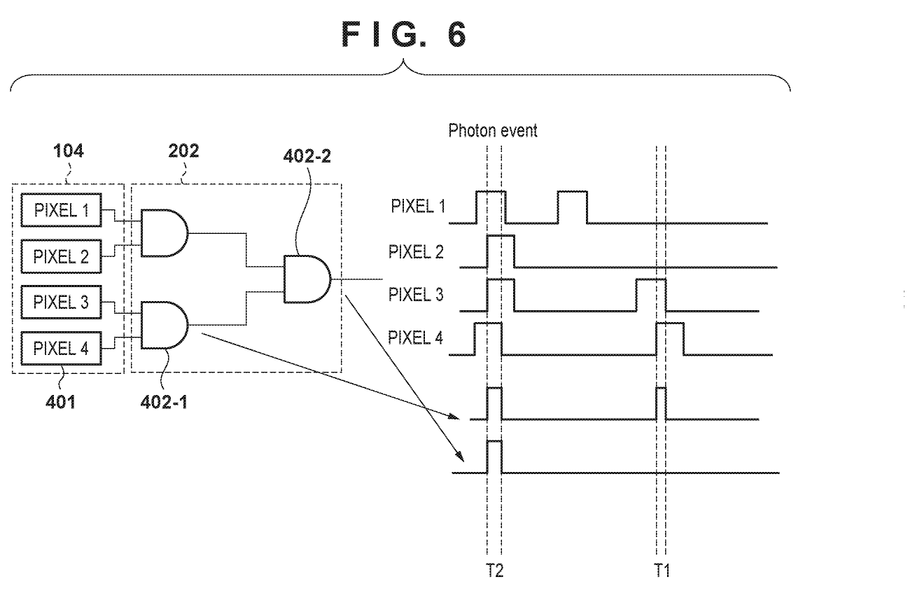

The operation of the circuit shown in FIG. 5 will be described with reference to FIG. 6. Here, for the sake of descriptive simplicity, assume that four pixels 1 to 4 are arranged in the pixel block 104. When a photon enters the pixel 401, the pixel 401 outputs a pulse. When only one of the four pixels outputs a pulse, the AND circuits 402-1 and 402-2 generate no output. That is, the counter 203 does not perform a count operation.

When photons are input to the pixel 1 and the pixel 2 with timings overlapping each other, the AND circuit 402-1 generates an output. At this time, the logic circuit outputs the number of detection signals generated in parallel. In this case, the logic circuit outputs a signal indicating 2. At this time, the signal indicating 2 is input to the lower bit of the counter 203, and a count operation is performed. FIG. 6 shows a state in which photons enter the pixel 3 and the pixel 4 at the same timing T1 so that the AND circuit 402-1 outputs a pulse. In this case as well, a signal indicating 2 corresponding to the number of detection signals is input to the lower bit of the counter 203, and a count operation is performed.

When photons are input to the pixels 1 to 4 in the pixel block 104 in parallel with timings overlapping each other, pulses are output from two AND circuits 402-1 in the first stage as shown at a timing T2 in FIG. 6. Furthermore, a pulse is also output from the AND circuit 402-2 in the second stage. The pulse from the AND circuit 402-2 is input to the flip-flop in the second stage in the counter 203. In this case, only the signal from the AND circuit 402-2 in the second stage, the signal indicating 4 corresponding to the number of the detecting signals, can be output to the counter 203. At this time, the signal from the AND circuit 402-1 in the first stage, the signal indicating 2 corresponding to the number of the detecting elements, is not input to the first stage in the counter 203. Since one pulse is input to the input of the flip-flop in the second stage, the counter 203 counts 2.

Even if photons are input to pixels in parallel in time, as shown in FIG. 6, detection signals output from the pixels are output with slight differences in signal width and timing deviations. Even in this case, the logic circuit can detect the number of detection signals while considering the timings to be parallel or simultaneous. In this manner, the count operation is performed only when multiple pixels 401 detect photons in parallel. When only one pixel 401 reacts, the count operation is not performed. When only one pixel 401 in the pixel block 104 detects a photon, this is likely caused by noise. Hence, a false operation due to false detection can be suppressed. Furthermore, since the counter 203 can capture a count value only when multiple pixels 401 detect photons in parallel; this can suppress an increase in circuit scale even if the pixels 401 increase in number, thereby suppressing an increase in operating power.

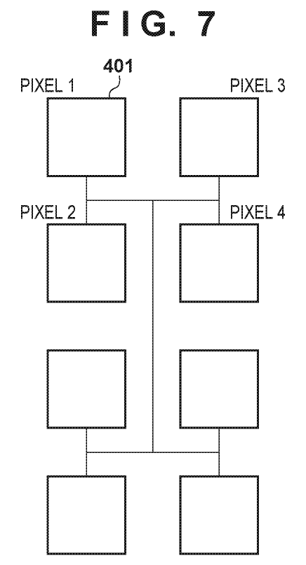

When constituting the pixel block 104 by eight pixels 401, for example, the arrangement as shown in FIG. 7 is used. To show the physical arrangement of the pixels 401, the logic circuit is not shown in FIG. 7. When arranging the plurality of pixels 401 as shown in FIG. 7, the AND circuit can be arranged to be sandwiched between the pixel 1 and the pixel 2 to perform operation on the signal from the pixel 1 and the signal from the pixel 2.

### Event Detection

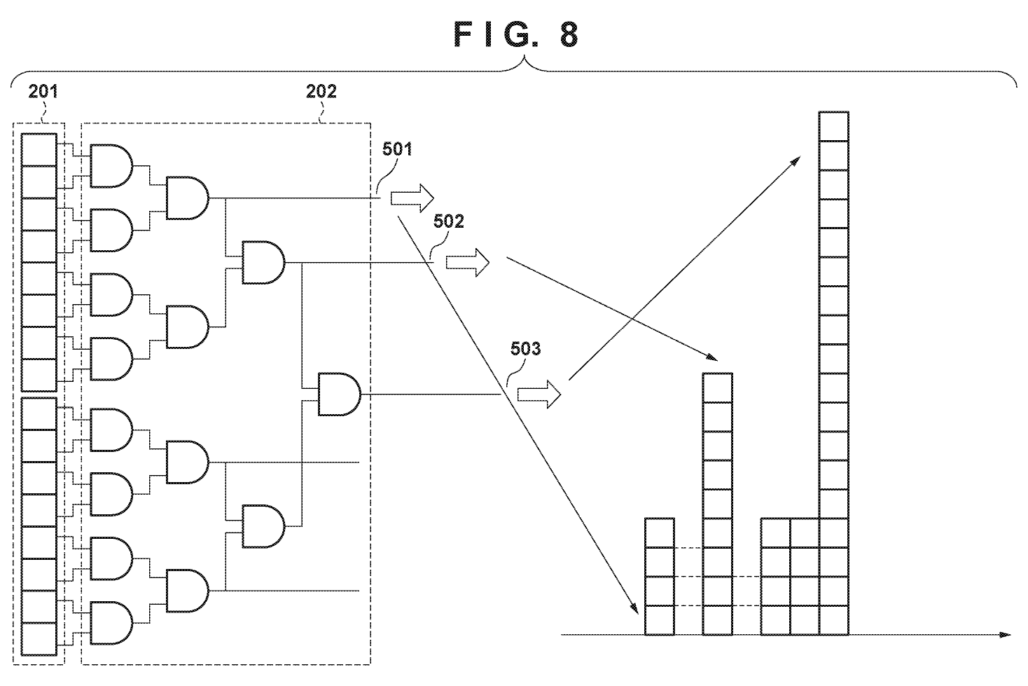

Next, an event detection method will be described. FIG. 8 is a view for explaining event detection according to the number of pixels detecting light in parallel. FIG. 8 shows an example in which sixteen pixels are arranged in the pixel block 104. Each pixel includes the detecting element. An output 501 of the AND circuit in the second stage is output when four pixels detect light in parallel. An output 502 of the AND circuit in the third stage is output when eight pixels detect light in parallel. An output 503 of the AND circuit in the fourth stage is output when sixteen pixels detect light in parallel. In this circuit example, a signal indicating the number of detection signals is output from the AND circuit when the four to sixteen detecting elements detect light in parallel. Note that in FIG. 8, the pulses output in correspondence to the outputs 501 to 503 are shown with heights corresponding to the number of detection signals detected in parallel. In practice, the pulses output in correspondence to the outputs 501 to 503 may have the same voltage level, for example, high level. As in the configuration example described with reference to FIG. 5, a pulse may be output from the logic circuit 202 when two or more detecting elements detect light in parallel.

Each of the outputs 501 to 503 is input to the flip-flops in a predetermined stage of the counter 203. If the number of pixels detecting light in parallel exceeds a threshold, it may be determined that an event is detected. Alternatively, the counter 203 counts the number of pixels detecting light in parallel, which is output by the logic circuit 202, and if the accumulated value obtained by counting exceeds a threshold, it may be determined that an event is detected.

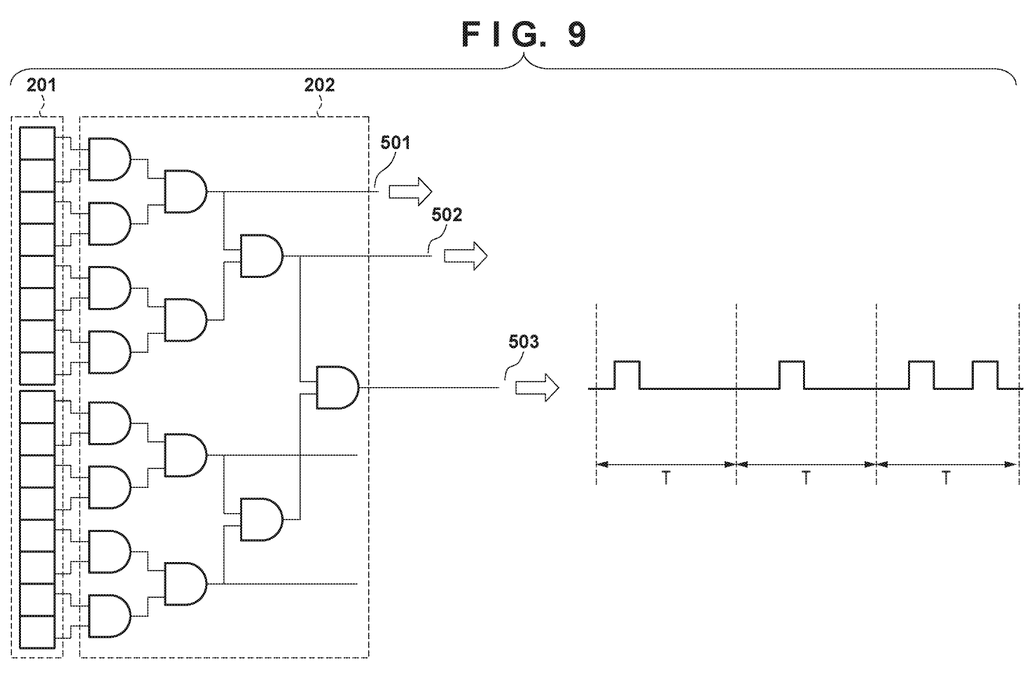

FIG. 9 is a view for explaining an example where an event is detected based on the accumulated count value of the counter 203 within a predetermined reference time. The accumulated count value of the counter 203 within a given reference time T and the accumulated count value of the counter 203 within the immediately preceding reference time T are compared and, if the difference therebetween is larger than a threshold, it may be determined that an event has occurred.

Event detection may be performed focusing on a specific number regarding the number of detection signals detected in parallel. Within the reference time T, the counter 203 accumulates only the output 503, which is output when sixteen pixels detect light. This accumulated value is compared with the accumulated value of the output 503 within the next reference time T. If the difference between the accumulated values is larger than a threshold, it may be determined that an event has occurred. The specific number of detection signals may be set to 8, thereby using the accumulated value within the reference time T for a case where detection signals are output from eight pixels in parallel. In this case, the counter 203 counts the output 502 instead of the output 503.

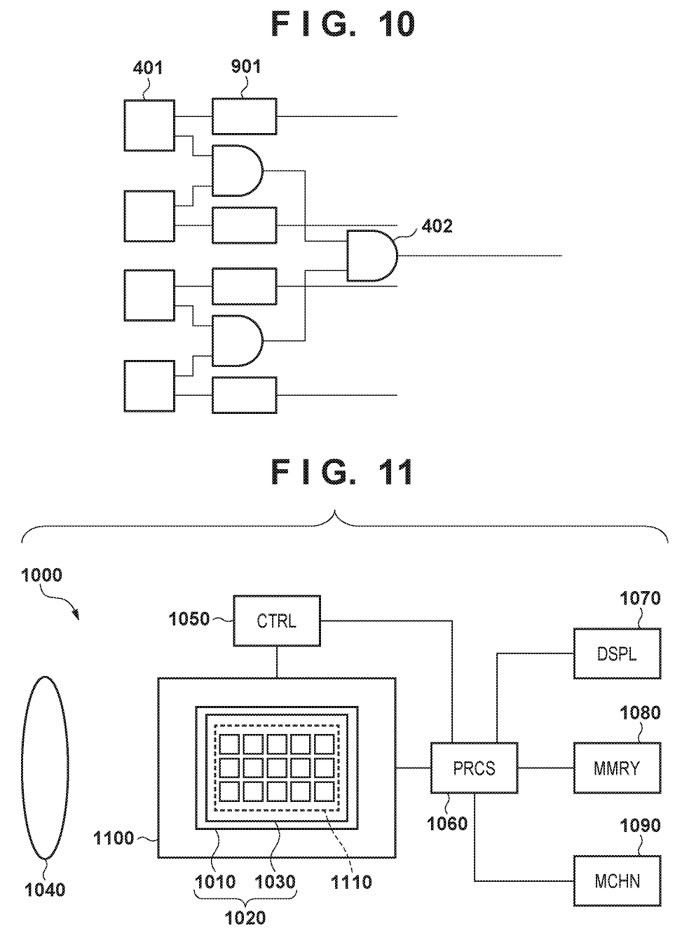

A circuit example in a case where a count operation for event detection and a normal count operation based on driving of each pixel are performed in parallel will be described with reference to FIG. 10. The pixel outputs the detection signal corresponding to incident light. The output from the pixel 401 is input not only to the AND circuit 402 but also to a counter 901 that counts the detection signals from each pixel. The count operation for each pixel can also be performed by the counter 901. In the example shown in FIG. 10, when the AND circuit 402 detects an event, the count value of the counter 901 for each pixel at this time is acquired. Thus, image data when the event has been detected can be obtained by the counter 901.

According to the present disclosure, it is possible to suppress an increase in scale of a circuit for event detection.

### Application Example of Photoelectric Conversion Apparatus to Equipment

The following is a description of equipment 1000 that includes a semiconductor apparatus 1100 including a package 1020 on which a semiconductor chip 1110 including a photoelectric conversion apparatus according to the above-described embodiment is mounted, as shown in FIG. 11. The semiconductor chip 1110 is accommodated in the package 1020 and mounted on the equipment 1000. In the arrangement shown in FIG. 11, the semiconductor chip 1110 includes the photoelectric conversion apparatus according to the embodiment described above. The semiconductor apparatus 1100 can include the package 1020 including a base 1010 on which the semiconductor chip 1110 is fixed and a light transmissive member 1030 such as glass that faces the semiconductor chip 1110. The package 1020 can be provided with joining members such as wires and bumps that connect inner leads provided on the base 1010 to terminals such as pad electrodes provided on the semiconductor chip 1110.

The equipment 1000 can include at least one of an optical apparatus 1040, a control apparatus 1050, a processing apparatus 1060, a display apparatus 1070, a storage apparatus 1080, and a mechanical apparatus 1090. The optical apparatus 1040 is implemented by, for example, a lens, a shutter, and a mirror. The control apparatus 1050 controls the semiconductor chip 1110. The control apparatus 1050 is, for example, a semiconductor device such as an ASIC.

The processing apparatus 1060 processes a signal output from the photoelectric conversion apparatus included in the semiconductor chip 1110. The processing apparatus 1060 is a semiconductor device such as a CPU or an ASIC for forming an Analog Front End (AFE) or a Digital Front End (DFE). For example, an image may be generated based on an image capturing signal at the time of detecting an event. The display apparatus 1070 is an EL display device or a liquid crystal display device that displays an information image obtained by the semiconductor chip 1110. The storage apparatus 1080 is a magnetic device or a semiconductor device that stores the information image obtained by the semiconductor chip 1110. The storage apparatus 1080 is a volatile memory such as an SRAM or a DRAM, or a nonvolatile memory such as a flash memory or a hard disk drive.

The mechanical apparatus 1090 includes a moving or propulsion unit such as a motor or an engine. In the equipment 1000, the signal output from the semiconductor chip 1110 is displayed on the display apparatus 1070 or transmitted to an external apparatus by a communication apparatus (not shown) included in the equipment 1000. Hence, the equipment 1000 may further include the storage apparatus 1080 and the processing apparatus 1060 in addition to the memory circuits and arithmetic circuits included in the semiconductor chip 1110. The mechanical apparatus 1090 may be controlled based on the signal output from the semiconductor chip 1110.

The equipment 1000 is suitable for electronic equipment such as an information terminal which has a shooting function, for example, a smartphone or a wearable terminal, or a camera, for example, an interchangeable lens camera, a compact camera, a video camera, or a monitoring camera. The mechanical apparatus 1090 in the camera can drive the components of the optical apparatus 1040 in order to perform zooming, an in-focus operation, and a shutter operation. Alternatively, the mechanical apparatus 1090 in the camera can move the optical apparatus 1040 in order to perform an anti-vibration operation.

Furthermore, the equipment 1000 can be transportation equipment such as a vehicle or a ship. The mechanical apparatus 1090 in the transportation equipment can be used as a moving apparatus. The equipment 1000 as the transportation equipment is suitable for equipment that transports the semiconductor chip 1110 or equipment that uses a shooting function to assist and/or automate drive steering. The processing apparatus 1060 for assisting and/or automating drive steering can perform, based on the information obtained by the semiconductor chip 1110, processing for operating the mechanical apparatus 1090 as a moving apparatus. Alternatively, the equipment 1000 may be medical equipment such as an endoscope, measurement equipment such as a distance measurement sensor, analysis equipment such as an electron microscope, office equipment such as a copy machine, or industrial equipment such as a robot.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-027217, filed Feb. 21, 2025 which is hereby incorporated by reference herein in its entirety.

What is claimed is:

1. A photoelectric conversion apparatus comprising a plurality of detecting elements each configured to detect light and output a detection signal, a logic circuit configured to output the number of detection signals output from the plurality of detecting elements in parallel, and a counter configured to be supplied with an output of the logic circuit,
wherein the counter accumulates a value corresponding to an output of the logic circuit.

2. The apparatus according to claim 1, wherein
the counter is a binary counter constituted by a plurality of counting portions connected in series, and an output of the logic circuit is input to a counting portion where a signal corresponding to the number of detection signals output in parallel has a predetermined weight of the counter.

3. The apparatus according to claim 1, wherein
in a case where there are several numbers of detection signals output from the plurality of detecting elements in parallel, the logic circuit supplies a signal corresponding to the largest number of detection signals to a counting portion having a predetermined weight of the logic circuit.

4. The apparatus according to claim 1, wherein
in a case where an accumulated value of the counter exceeds a threshold, it is determined that an event has occurred.

5. The apparatus according to claim 1, wherein
in a case where a difference between an accumulated value of the counter within a reference time and an accumulated value of the counter within a reference time immediately preceding the reference time exceeds a threshold, it is determined that an event has occurred.

6. The apparatus according to claim 1, wherein
in a case where the number of detection signals output in parallel is a specific number, the logic circuit supplies an output to the counter.

7. The apparatus according to claim 6, wherein
in a case where an accumulated value obtained by counting an output supplied when the number of detection signals is a specific number exceeds a threshold, it is determined that an event has occurred.

8. The apparatus according to claim 6, wherein
in a case where a difference between an accumulated value of the counter within a reference time when the number of detection signals is a specific number and an accumulated value of the counter within a reference time immediately preceding the reference time when the number of detection signals is a specific number exceeds a threshold, it is determined that an event has occurred.

9. The apparatus according to claim 1, wherein
the plurality of detecting elements are avalanche photodiodes.

10. The apparatus according to claim 1, further comprising a counter configured to count a detection signal of each of the plurality of detecting elements.

11. The apparatus according to claim 1, wherein
the logic circuit includes an AND circuit, and the AND circuit detects the number of detection signals output in parallel.

12. Equipment comprising:
a photoelectric conversion apparatus defined in claim 1; and
a processing apparatus configured to process a signal output from the photoelectric conversion apparatus.
